(19) United States
(12) Patent Application Publication
(10) Pub. No.: US 2020/0086451 A1
(43) Pub. Date: Mar. 19, 2020

(54) METHOD FOR PROCESSING A SURFACE OF A METAL OBJECT SUCH AS A METAL SYNCHRONIZING RING FOR MANUAL TRANSMISSIONS

(71) Applicant: Aktiebolaget SKF, Gothenburg (SE)

(72) Inventors: Norbert Huhn, Schweinfurt (DE); Thomas Fetzer, Schramberg (DE); Ulrich Lang, Mühlheim (DE); Ralph Meeuwenoord, Nieuwegein (NL); Patrice Ribault, Vouvray (FR)

(21) Appl. No.: 16/559,737

(22) Filed: Sep. 4, 2019

(30) Foreign Application Priority Data
Sep. 17, 2018 (DE) 102018215776.6

(51) Int. Cl. B24B 31/00; F16D 23/02

(52) U.S. Cl. CPC B24B 31/006; F16D 2250/0038; F16D 2300/10; F16D 23/025

(57) ABSTRACT

A method includes providing a metal ring and pastelessly slide-grinding at least one surface of the metal ring with grinding bodies, preferably until a predefined surface topography of the metal ring is achieved, which surface topography preferably has an Rsk value that is greater than or equal to −0.25 and/or an Rk value between 0.3 and 1.35 and/or Rpk value between 0.05 and 0.4 and/or an Rvk value between 0.2 and 1.2 and/or an Ra value between 0.1 and 0.4.

### CROSS-REFERENCE

This application claims priority to German patent application no. 10 2018 215 776.6, filed on Sep. 17, 2018, and DE 10 2018 216 615.3, filed on Sep. 27, 2018, the contents of both of which are fully incorporated herein by reference.

### TECHNOLOGICAL FIELD

The present disclosure is directed to a method for processing a surface of a metal object, in particular a metal surface of a metal synchronizing ring for use in vehicle manual transmissions, also dual-clutch transmissions.

### BACKGROUND

Various metal objects, for example, metal rings like the ones that are used in bearings for transmissions or the like, require a finely processed surface that satisfies certain required friction parameters. Synchronous manual transmissions, for example, include steel or other metal rings that, in use, come into contact with brass rings. These steel rings must have a surface that keeps wear low when they make contact with the brass rings. This is achieved by providing the surface with a topography that is sufficiently rough to be able to hold lubricant.

To date the required surface topography of such metal rings has been produced by complex, cost-intensive honing processes. However, when metal rings have honed surfaces, the friction values change over the course of use due to the contact between the metal ring and the brass ring. This is because peaks of the surface structure are initially ground down by the contact between the steel rings and the brass rings. This change of the friction values or friction coefficients that arises in the first approximately 100 shift cycles of a transmission that uses such a metal ring is referred to as “green shiftability.” Furthermore the grinding down of the peaks of the steel rings leads to wear of the brass rings.

It is also known to use a slide-grinding method which usually more advantageous than honing. “Slide-grinding” is understood to be a method for surface processing in which the workpieces to be processed are placed in a container together with grinding bodies, so-called chips, and a paste-type or pasty additive as bulk material. The paste-type additive is comprised of fine hard particles that are supplied to the process water in addition to the grinding bodies. Moving the container causes a relative movement between the workpiece and the grinding bodies, which movement leads to a material removal on the workpiece. The surface appearance of the workpieces can be adjusted, inter alia, by the kind of grinding bodies used.

The use of such a slide-grinding method leads to a quality of the surface of the metal rings that achieves functional friction and wear values with contact with brass rings that are coated with molybdenum. However, since the slide-grinding method produces a substantially smooth surface, lubricant adheres poorly to the surface and a direct metal contact between the metal rings and adjacent surfaces, for example, uncoated brass surfaces, can occur. Especially when the adjacent surfaces are brass surfaces that are softer than the steel rings, the direct contact between the surfaces can lead to very high wear on the brass surfaces and unintentionally reduce their service life.

### SUMMARY

It is therefore an aspect of the present disclosure to provide a method for processing a surface of a metal object, in particular of a metal ring for use as a synchronizing ring of a manual transmission, which method optimizes friction characteristics and simultaneously minimizes wear if the surface of the metal object comes into contact with a brass surface.

The method is used for final processing of a metal object such as, for example, a metal ring that is used in a bearing or transmission, as a synchronizing ring, for example. The metal object or metal ring can be comprised in particular of steel, for example, hardened steel. Metal rings made from steel are often brought into contact with brass surfaces as has already been described above. In order to keep the wear of the brass surface low, while simultaneously providing the functionally required friction value, the metal object is subjected to a slide-grinding step.

In this process, at least one surface of the metal object is slide-ground. In order to achieve a particularly good, i.e., optimized, surface topography, the slide-grinding is carried out as pasteless slide-grinding with grinding bodies. This means that in comparison to previous slide-grinding methods the grinding paste is omitted. The inventors have found that due to the omission of the grinding paste specifically the peaks of the surface are smoothed, but simultaneously sufficient scoring is maintained in the surface structure to achieve an optimal topography of the surface. An “optimal topography” means that on the one hand lubricant can adhere to the surface, and on the other hand the peaks of the surface structure are already ground down. In this way essentially the same friction values can be made available in comparison to previous methods, wherein peaks are first ground down or wherein lubricant is only poorly adhered, both directly at the start of use and constantly over the service life.

The more uniform friction values can thus be achieved by the peaks already being smoothed on the one side, and on the other side lubricant can adhere better to the surface of the metal object due to the “structured,” i.e., not completely smoothed, surface. A required heat dissipation is thereby improved. Due to a reduced fluctuation of the friction values a local heating of the surfaces and thus their edge-layer reactions are reduced in the lubricated state.

Furthermore the method including a slide-grinding step as described above has the advantage of being cheaper than a honing method since the method in itself can be carried out in an advantageous manner and no honing is required. At the same time it has been found that the green shiftability, i.e., the fluctuation of the friction coefficients in the first approximately 100 shift cycles of a transmission, is improved with use of a metal ring, processed as described above, in the transmission in comparison to a ring that has been processed by a honing method.

The grinding bodies used, so-called chips, can have any desired shapes. For example, they can be round, square, or pyramid-shaped. In particular the chips can be manufactured from ceramic materials.

According to one embodiment the step of slide-grinding is performed until a predefined reduction of the material peaks on the surface of the metal object is achieved. However, the metal object is not slide ground until a mirror-like smooth surface is achieved, as is achieved with the use of a paste after sufficiently long process duration.

In particular the surface topography can have a so-called Rsk value in the direction of the relative movements of the two contacting surfaces, for example, Rskx, for rings that rotate relative to each other, that is greater than or equal to −0.25. The Rsk value defines the asymmetry of the amplitude density curve, wherein negative values indicate a surface having good carrier behavior, and positive values indicate a profile having a high proportion of profile peaks. The surface topography can furthermore be defined by an Rk value of 0.3-1.35, an Rpk value of 0.05-0.4, an Rvk value of 0.2-1.2, and an Ra value of 0.1-0.4. Rk defines the core roughness depth, Rpk defines the reduced peak height, Rvk defines the reduced scoring depth, and Ra defines the average roughness. A high Rpk value indicates sharp peaks, a high Rvk value indicates deep scoring, and a high Rk value indicates a profile having few peaks and little scoring. The sum of the values Rpk+Rk+Rvk yields the roughness depth of the surface, i.e., the distance from the highest peak to the deepest valley of the surface. The combination of the individual characteristics helps ensure that the interaction of the height-reduced peaks, the remaining scoring, the respective proportions, and the overall size of the projection of the roughness makes available the functionally optimized topography.

Up to now, slide-grinding methods usually require more than two hours, which period comprises both the slide-grinding itself including grinding bodies and paste, and a rinsing for the removal of the grinding bodies and the paste. In comparison to these previous slide-grinding methods the paste-less slide-grinding, as it is used here, can be carried out over a reduced period of 0.8 to 1.2 hours. In particular the new slide-grinding is carried out over a period of 1 hour. Here the step of the slide-grinding also comprises both the grinding itself and a rinsing of the metal object, wherein however only the grinding bodies and the removed portions of the workpieces and the grinding bodies are washed away. For example, the grinding can be carried out over a period of 0.8 hours, and the subsequent rinsing can be carried out over a period of 0.2 hours.

As already described above, the slide-grinding, as it is described herein, is to directly adjoin a step of a previous mechanical processing of the metal object, such as, for example, reshaping, hard turning, or grinding. A honing of the metal object can thus be omitted, whereby in particular the manufacturing costs can be reduced.

According to a further aspect a metal object is presented that can in particular be a metal ring such as a synchronizing ring of a manual transmission. The surface of the metal object is processed by the method as it is described above in order to obtain a defined surface topography.

Further advantages and advantageous embodiments are specified in the description, the drawing, and the claims. Here in particular the combinations of features specified in the description and in the drawing are purely exemplary, so that the features can also be present individually or combined in other ways.

In the following the invention shall be described in more detail using an exemplary embodiment depicted in the drawing. Here the exemplary embodiment and the combinations shown in the exemplary embodiment are purely exemplary and are not intended to define the scope of the invention. This scope is defined solely by the pending claims.

### BRIEF DESCRIPTION OF THE DRAWING

FIG. 1 is a flowchart showing sequence of a method for processing the surface of a metal object according to an embodiment of the present disclosure.

### DETAILED DESCRIPTION

In the following, identical or functionally equivalent elements are designated by the same reference numbers.

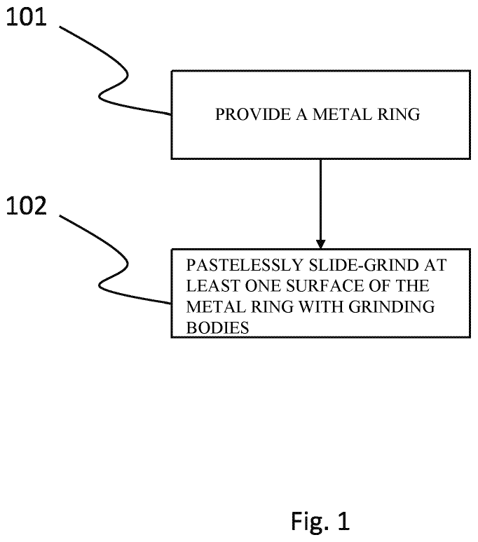

FIG. 1 shows a method for processing the surface of a metal object such as a synchronizing ring of a manual transmission. The method includes a first step 101 of a raw processing of a metal object. In this step the metal object receives its coarse shape, for example, as a metal ring. The metal object can be comprised in particular of steel, for example, hardened steel. With use in transmissions, metal rings made of steel, for example, can be used in combination with brass rings. Since brass is softer than steel, a contact between the steel rings and the brass rings leads to wear of the brass rings.

In order to keep the wear low of the adjacent brass surface, the metal ring is subjected to a slide-grinding in a step 102 directly after a previous mechanical processing, such as, for example, reshaping, hard turning, or grinding, without a previous honing step.

Here the surface of the metal ring is slide ground. In order to achieve a surface topography that is optimized for an adhesion of lubricant and simultaneously has no peaks that would be initially ground down in use (i.e., would lead to wear of the adjacent surface), the slide-grinding is carried out as pasteless slide-grinding with grinding bodies. This means that the grinding paste is omitted. The peaks of the surface of the metal ring are thereby specifically smoothed; sufficient scoring is simultaneously maintained in the surface structure so that lubricant can adhere. In this way friction values can be optimized in comparison to previous methods over the entire service life in particular with contact of the surface with an uncoated brass surface. Due to such controlled friction values the wear of the contacting brass surface is also reduced.

The grinding bodies used in slide-grinding can have any desired shapes and can be configured, for example, round, square, or pyramid-shaped. The grinding bodies can be comprised of a ceramic material.

The pasteless slide-grinding of step 102 is carried out until a predefined surface topography is achieved. For this purpose experience values can be used over the required duration of the slide-grinding. Alternatively the surface topography can be monitored during the slide-grinding, and the process can be stopped as soon as the defined values are achieved. In particular only the peaks of the surface profile are flattened here, however the metal ring is not slide-ground until a completely smooth surface is achieved. In particular the surface topography can have a Rsk value that is greater or equal to −0.25.

Step 102 can be carried out over a period of 0.8 to 1.2 hours and can include both the grinding itself and a rinsing of the grinding bodies from the metal object. For example, the grinding can be carried out over a period of 0.8 hours, and the subsequent rinsing can be carried out over a period of 0.2 hours.

In summary a method is provided for processing a surface of a metal object, in particular of a metal ring. Here the processing of the surface is effected by pasteless slide-grinding, whereby a surface structure is obtained, using which an optimized contact of the processed surface with, for example, uncoated brass surfaces, and thus an improved function with simultaneously minimized wear of the surfaces can be achieved in comparison to previous methods.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved processing of metal rings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

101 Method step
102 Method step

What is claimed is:

1. A method comprising:
providing a metal ring; and
pastelessly slide-grinding at least one surface of the metal ring with grinding bodies.

2. The method according to claim 1, wherein the slide-grinding is carried out until a predefined surface topography of the at least one surface of the metal ring is achieved.

3. The method according to claim 2, wherein the predefined surface topography has an Rsk value that is greater than or equal to −0.25.

4. The method according to claim 3, wherein the predefined surface topography has an Rk value between 0.3 and 1.35, an Rpk value between 0.05 and 0.4, an Rvk value between 0.2 and 1.2, and/or an Ra value between 0.1 and 0.4.

5. The method according to claim 4, wherein the slide-grinding is carried out over a period of 0.8 to 1.2 hours.

6. The method according to claim 4, including rinsing the metal ring after the slide grinding.

7. The method according to claim 1, wherein the slide-grinding directly immediately follows a mechanical processing of the metal ring.

8. The method according to claim 5, wherein the metal object is comprised of hardened steel.

9. The method according to claim 4, wherein the slide-grinding comprises placing the metal ring in a container with grinding chips and moving the container to cause a relative movement between the metal ring and the grinding bodies.

10. A steel ring formed according to the method of claim 4.

11. A manual transmission comprising:
the steel ring according to claim 9 as a synchronizing ring; and
a brass ring mounted adjacent to the synchronizing ring and configured to contact the steel ring.
